(19) United States
(12) Patent Application Publication
(10) Pub. No.: US 2024/0085905 A1
(43) Pub. Date: Mar. 14, 2024

(54) VEHICLE, VEHICLE CONTROL METHOD, AND STORAGE MEDIUM

(71) Applicant: TOYOTA JIDOSHA KABUSHIKI KAISHA, Toyota-shi (JP)

(72) Inventors: Kosuke AKATSUKA, Mishima-shi (JP); Rio SUDA, Toyota-shi (JP); Toru TAKASHIMA, Susono-shi (JP)

(73) Assignee: TOYOTA JIDOSHA KABUSHIKI KAISHA, Toyota-shi (JP)

(21) Appl. No.: 18/220,887

(22) Filed: Jul. 12, 2023

(30) Foreign Application Priority Data
Sep. 13, 2022 (JP) 2022-145454

(51) Int. Cl. G05D 1/00

(52) U.S. Cl. CPC G05D 1/0061; G05D 1/0022; G05D 2201/0213

(57) ABSTRACT

The vehicle includes a driving operation member that is operated by an operator to perform steering, acceleration, and deceleration, a stop maintaining device that maintains a stop state, and a control device. In the remote control mode, the control device communicates with the remote operation target vehicle, transmits information reflecting the operation amount of the driving operation member to the remote operation target vehicle, and presents information received from the remote operation target vehicle to the operator. When the stop state of the vehicle is not maintained by the stop maintaining device, the control device prohibits the remote control mode.

### CROSS-REFERENCE TO RELATED APPLICATION

This application claims priority to Japanese Patent Application No. 2022-145454 filed on Sep. 13, 2022, incorporated herein by reference in its entirety.

### BACKGROUND

### 1. Technical Field

The present disclosure relates to a technique for remotely controlling a vehicle.

### 2. Description of Related Art

Japanese Unexamined Patent Application Publication No. 2004-206218 (JP 2004-206218 A) discloses a vehicle remote control system for remotely controlling a vehicle. A remote operator enters a remote control room (remote cockpit) dedicated to remote control, and performs remote control of a target vehicle by operating a device installed in the remote control room.

### SUMMARY

According to the technology disclosed in JP 2004-206218 A, it is necessary to install a remote control room dedicated to remote control, which is expensive.

One object of the present disclosure is to provide a new technique for remotely operating a vehicle.

A first aspect relates to a vehicle.

The vehicle includes the following:
a driving operation member operated by an operator to perform steering, accelerating, and decelerating;
a stop maintaining device that maintains a stop state; and
a control device.

In a remote operation mode, the control device communicates with a remote operation target vehicle,
in the remote operation mode, the control device transmits information reflecting an operation amount of the driving operation member to the remote operation target vehicle,
in the remote operation mode, the control device shows information received from the remote operation target vehicle to the operator.

When a stop state of the vehicle is not maintained by the stop maintaining device, the control device prohibits the remote operation mode.

A second aspect relates to a vehicle control method for controlling a vehicle. The vehicle includes the following:
a driving operation member operated by an operator to perform steering, accelerating, and decelerating;
a stop maintaining device that maintains a stop state.

The vehicle control method includes:
communicating with a remote operation target vehicle in a remote operation mode;
transmitting information reflecting an operation amount of the driving operation member to the remote operation target vehicle, in the remote operation mode;
showing information received from the remote operation target vehicle to the operator, in the remote operation mode; and
prohibiting the remote operation mode when a stop state of the vehicle is not maintained by the stop maintaining device.

A third aspect relates to a storage medium that stores a vehicle control program that is executed by a computer and that controls a vehicle.

The vehicle includes the following:
a driving operation member operated by an operator to perform steering, accelerating, and decelerating; and
a stop maintaining device that maintains a stop state.

The vehicle control program causes a computer to execute the following:
communicating with a remote operation target vehicle in a remote operation mode;
transmitting information reflecting an operation amount of the driving operation member to the remote operation target vehicle, in the remote operation mode;
showing information received from the remote operation target vehicle to the operator, in the remote operation mode; and
prohibiting the remote operation mode when a stop state of the vehicle is not maintained by the stop maintaining device.

According to the present disclosure, instead of a terminal dedicated to remote control, the driving operation member originally provided in the vehicle is used for remote control. The operator can remotely control the remote operation target vehicle by using the driving operation member of the vehicle. Since it is not necessarily necessary to prepare a terminal dedicated to remote control, it is possible to suppress the cost of introducing the remote control system.

Further, when the stop state of the vehicle is not maintained by the stop maintaining device, the remote operation mode is prohibited. Thus, the vehicle is suppress from being moved by the operation of the driving operation member during the remote operation mode. That is, it is possible to remotely operate the remote operation target vehicle while securing the safety of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an outline of a remote control system according to an embodiment;

FIG. 2 is a conceptual diagram for explaining a normal mode and a remote control mode of the vehicle according to the embodiment;

FIG. 3 is a block diagram illustrating a configuration example of a vehicle according to the embodiment;

FIG. 4 is a block diagram illustrating a configuration example of a vehicle to be remotely operated according to the embodiment;

FIG. 5 is a flowchart illustrating an example of processing related to the start of the remote control mode according to the embodiment;

FIG. 6 is a flowchart illustrating another example of processing related to the start of the remote operation mode according to the embodiment.

### DETAILED DESCRIPTION OF EMBODIMENTS

Embodiments of the present disclosure will be described with reference to the accompanying drawings.

### 1. Overview

Consider remote operation of a vehicle. Remote control is a concept including remote driving, remote support, and remote control. In general, a terminal dedicated to remote control is used for remote control of a vehicle. However, it is expensive to manufacture and install a terminal dedicated to remote control. Further, a remote control member such as a handle, an accelerator pedal, and a brake pedal is provided in a terminal dedicated to remote control, but the reliability of the remote control member is not necessarily ensured.

Therefore, according to the present embodiment, a driving operation member such as a handle, an accelerator pedal, and a brake pedal originally provided in a general vehicle is also used as a remote operation member. That is, a certain vehicle is used for remote control of another vehicle.

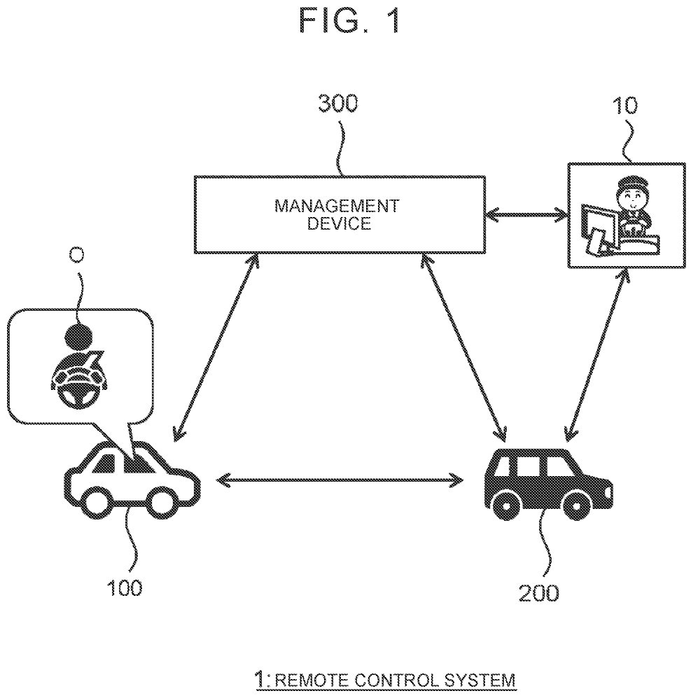

FIG. 1 is a conceptual diagram illustrating an outline of a remote control system 1 according to the present embodiment. The remote control system 1 includes a vehicle 100 and a remote operation target vehicle 200. The remote operation target vehicle 200 is a vehicle that is a target of remote control. The remote operation target vehicle 200 may be an autonomous vehicle. The vehicle 100 is a vehicle used when the remote operation target vehicle 200 is remotely operated. Of course, the vehicle 100 can travel normally. That is, the vehicle 100 is used for remote control, but is not dedicated to remote control. The operator O rides on the vehicle 100. The operator O can drive the vehicle 100 as normal, or can remotely control the remote operation target vehicle 200 using the vehicle 100.

The remote control system 1 further includes a management device 300 that manages the remote control. Typically, the management device 300 is a management server on the cloud. The management server may include a plurality of servers that perform distributed processing. The vehicle 100, the remote operation target vehicle 200, and the management device 300 can communicate with each other via a communication network. The vehicle 100 and the remote operation target vehicle 200 can communicate with each other via the management device 300. In addition, the vehicle 100 and the remote operation target vehicle 200 may directly communicate with each other without passing through the management device 300.

The remote operator terminal 10 is a terminal dedicated to remote control and is operated by a remote operator. The remote control system 1 according to the present embodiment does not exclude the remote operator terminal 10. That is, the remote control system 1 may include the remote operator terminal 10.

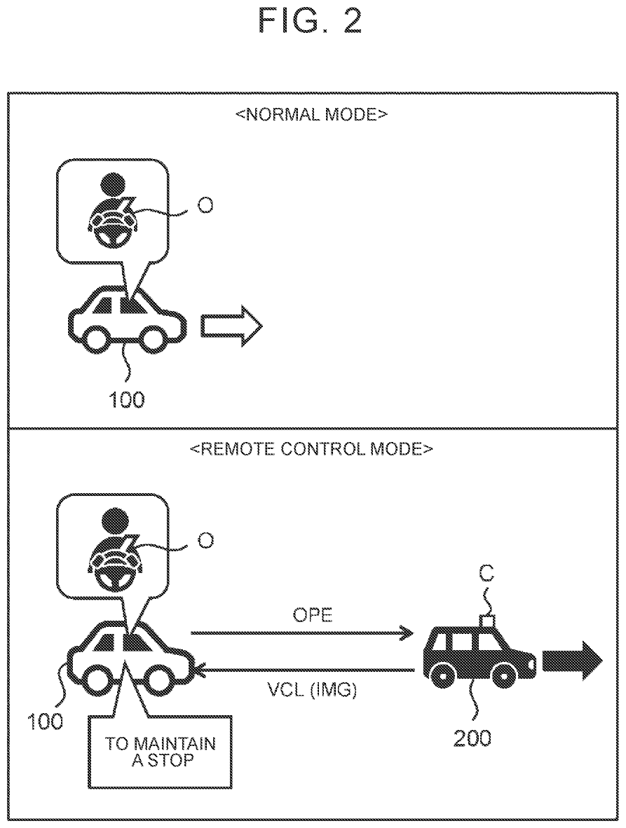

FIG. 2 is a conceptual diagram for describing the “normal mode” and the “remote operation mode” of the vehicle 100 according to the present embodiment.

In the normal mode, the operator O normally operates the vehicle 100. In the normal mode, the operator O is a driver of the vehicle 100. More specifically, the vehicle 100 includes driving operation members such as a steering wheel, an accelerator pedal, and a brake pedal that are operated by the operator O to steer, accelerate, decelerate, and the like the vehicle 100. The operator O drives the vehicle 100 by operating the driving operation member. The vehicle 100 travels in accordance with an operation amount of the driving operation member by the operator O.

The remote control mode is a mode for remotely controlling the remote operation target vehicle 200. In the remote control mode, the operator O is a remote operator that remotely controls the remote operation target vehicle 200. At least during remote control, the vehicle 100 and the remote operation target vehicle 200 communicate with each other or directly with each other via the management device 300.

Various sensors including a camera C are mounted on the remote operation target vehicle 200. The camera C captures an image of the surroundings of the remote operation target vehicle 200 and acquires image IMG. The vehicle information VCL includes information obtained by various sensors, and includes at least image IMG obtained by the camera C. The remote operation target vehicle 200 transmits the vehicle information VCL to the vehicle 100.

The vehicle 100 receives the vehicle information VCL transmitted from the remote operation target vehicle 200. The vehicle 100 presents the received vehicle information VCL to the operator O. Typically, the vehicles 100 include a display device, and display IMG and the like on the display device. The operator O looks at the displayed information, recognizes a situation around the remote operation target vehicle 200, and performs remote control of the remote operation target vehicle 200. At this time, the operator O operates the driving operation member of the vehicle 100.

The operation information OPE is information reflecting an operation amount of the driving operation member by the operator O. The operation information OPE may include an operation amount of the driving operation member, or may include an actuator control amount calculated based on the operation amount. The vehicle 100 transmits the operation information OPE to the remote operation target vehicle 200. The remote operation target vehicle 200 receives the operation information OPE transmitted from the vehicle 100. The remote operation target vehicle 200 performs vehicle travel control in accordance with the received operation information OPE. Thus, the remote operation target vehicle 200 is remotely operated according to the operation amount of the driving operation member by the operator O.

In this way, remote control of the remote operation target vehicle 200 using the vehicle 100 is realized. However, there is a concern that the vehicle 100 may be moved by the operation of the driving operation member during the remote operation mode.

Therefore, according to the present embodiment, a “stop maintaining device” that is mounted on the vehicle 100 and maintains the stop state of the vehicle 100 is used. Examples of the stop maintaining device include a parking brake, Electric Parking Brake (EPB), and the like. When the stop maintaining device is activated, the stop state of the vehicle 100 is maintained. According to the present embodiment, the remote control mode is allowed only when the stop state of the vehicle 100 is maintained by the stop maintaining device. On the other hand, when the stop state of the vehicle 100 is not maintained by the stop maintaining device, the remote control mode is prohibited. Therefore, the vehicle 100 is suppressed from being moved by the operation of the driving operation member during the remote operation mode. That is, the remote control of the remote operation target vehicle 200 can be performed while securing the safety of the vehicle 100.

The vehicle 100 may be an XbyWire vehicle with at least one of steer-by-wire, drive-by-wire, brake-by-wire, and shift-by-wire functionality. In the normal mode, the vehicle 100 controls the actuator for XbyWire based on the operation amount of the driving operation member by the operator O. On the other hand, in the remote control mode, the vehicle 100 prohibits the operator O from controlling the actuator for XbyWire based on the operation amount of the driving operation member. This makes it possible to suppress unnecessary behavior of the vehicle 100 during the remote control mode. This is preferable from the viewpoint of energy saving.

For example, when the vehicle 100 has a drive-by-wire function, unnecessary driving force is suppressed from being generated during the remote operation mode. As a result, the stop state of the vehicle 100 is more reliably maintained. In addition, unnecessary energy consumption is suppressed. Further, since unnecessary driving noise is not generated, the surrounding pedestrian is suppressed from feeling uncomfortable with respect to the vehicle 100 being stopped.

As another example, if the vehicle 100 is equipped with a steer-by-wire feature, unnecessary movement of the tire of the vehicle 100 during the remote control mode is suppressed. Thus, unnecessary energy consumption is suppressed. Further, wear of the tire is suppressed. Further, unnecessary tire movement does not occur, and therefore, the surrounding pedestrian is suppressed from feeling uncomfortable with respect to the vehicle 100 that is stopping.

Further, according to the present embodiment, since remote control using the vehicle 100 is realized, it is not always necessary to prepare the remote operator terminal 10 dedicated to remote control. The number of remote operator terminals 10 may also be reduced. Therefore, it is possible to reduce the cost of introducing the remote control system 1.

Further, according to the present embodiment, the driving operation member originally provided in the vehicle 100 is used for remote control. No additional parts are required, which also contributes to cost reduction. In addition, the reliability of the driving operation member originally provided in the vehicle 100 is ensured, which is preferable.

The vehicle 100 may be one normally used by the operator O. The vehicles 100 may be privately owned vehicle (POV owned by the operator O). The operator O can perform remote control by operating the driving operation member of the vehicle 100, which is familiar to the operator O, which is preferable.

The remote control system 1 according to the present embodiment is applied to, for example, a remote taxi service. The operator O can remotely drive various remote operation target vehicles 200 existing at a remote location while riding on the vehicle 100.

Hereinafter, a specific example of the vehicle 100 and the remote operation target vehicle 200 will be described.

### 2. Specific Examples of Vehicles

### 2-1. Configuration Example

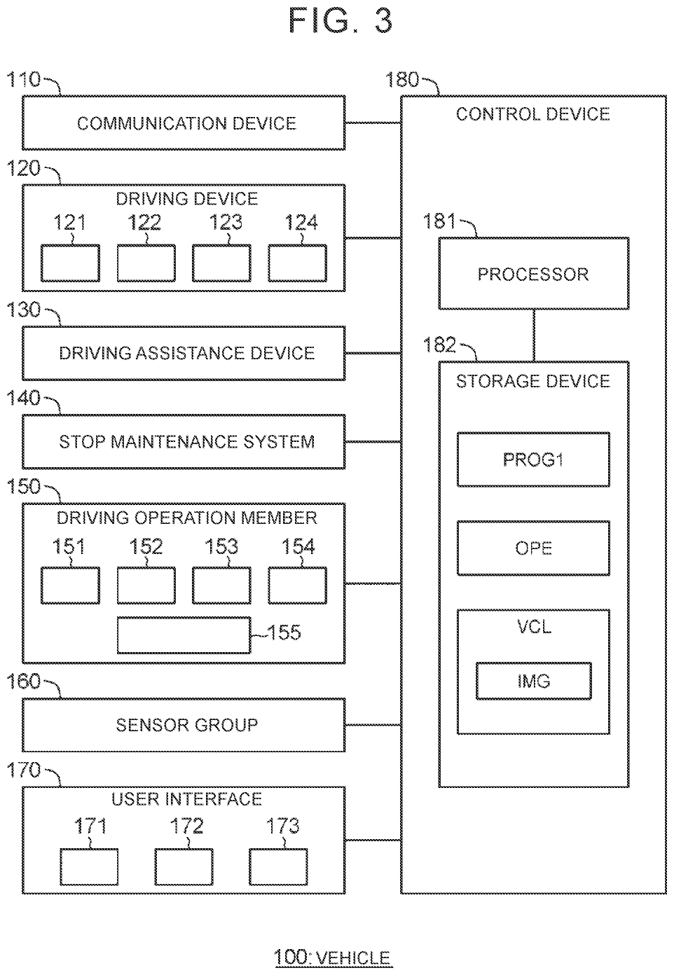

FIG. 3 is a block diagram illustrating a configuration example of the vehicle 100 according to the present embodiment. The vehicle 100 includes a communication device 110, a traveling device 120, a traveling assistance device 130, a stop maintaining device 140, a driving operation member 150, a sensor group 160, a user interface 170, and a control device 180.

The communication device 110 communicates with the outside of the vehicle 100. For example, the communication device 110 communicates with the remote operation target vehicle 200 and the management device 300.

The traveling device 120 includes an actuator for realizing traveling (steering, acceleration, and deceleration) of the vehicle 100. In particular, in the present embodiment, the vehicle 100 is an XbyWire vehicle, and the traveling device 120 includes an actuator for XbyWire.

For example, the traveling device 120 may include a steering actuator 121 for a steer-by-wire. The steering actuator 121 includes an electric motor for turning the wheels of the vehicle 100. The electric motor for turning the wheels is also called an Electric Power Steering (EPS).

As another example, the traveling device 120 may include a drive actuator 122 for a drive-by-wire. The drive actuator 122 includes, for example, a vehicle drive motor.

As yet another example, the traveling device 120 may include a brake actuator 123 for brake-by-wire. The brake actuator 123 includes, for example, an electric hydraulic pump.

As yet another example, the traveling device 120 may include a shift actuator 124 for shift-by-wire. The shift actuator 124 includes, for example, an electric motor for switching the gear position.

The traveling assistance device 130 assists the traveling of the vehicle 100. The traveling assistance device 130 includes at least one of a light, a winker, and a wiper. Examples of the light include a headlight, a brake lamp, and a fog lamp.

The stop maintaining device 140 maintains the stop state of the vehicle 100. For example, the stop maintaining device 140 is a parking brake or an electric parking brake. As another example, the stop maintaining device 140 may be a P (parking) range transmission. As yet another example, the stop maintaining device 140 may be a brake actuator 123 that generates a braking force sufficient to maintain the stop state of the vehicle 100. The stop maintaining device 140 may be a combination of these examples.

The driving operation member 150 is a member that is operated when the operator O drives the vehicle 100. The driving operation member 150 includes a steering wheel 151, an accelerator pedal 152, a brake pedal 153, and a shift lever (or shift switch) 154. Further, the driving operation member 150 includes a switch group 155. For example, the switch group 155 includes a switch for activating the traveling assistance device 130 described above.

The sensor group 160 detects a state of the vehicle 100. In particular, the sensor group 160 includes a sensor for detecting an operation amount and an operation state of the driving operation member 150. For example, the sensor group 160 includes a steering angle sensor that detects a steering angle of the steering wheel 151. In addition, the sensor group 160 includes an accelerator pedal sensor that detects a stroke amount of the accelerator pedal 152. The sensor group 160 includes a brake pedal sensor that detects a stroke amount of the brake pedal 153. Further, the sensor group 160 includes a gear position sensor that detects the position of the shift lever (or shift switch) 154. Further, the sensor group 160 includes a sensor that detects an operation state of the switch group 155.

Further, the sensor group 160 includes a sensor that detects an operation state of the stop maintaining device 140. For example, the sensor group 160 includes a sensor that detects an operating state of a parking brake or an electric parking brake.

The user interface 170 presents various kinds of information to the operator O, and receives input of various kinds of information from the operator O. For example, the user interface 170 includes a display device 171. Examples of the display device 171 include a display installed on an instrument panel, a car navigation monitor, a Head Up Display (HUD), and a Head Mounted Display (HMD. The user interface 170 may include a speaker 172. Further, the user interface 170 includes an input device 173. Examples of the input device 173 include a touch panel, a switch, and the like. The input device 173 may include a switch for switching the mode of the vehicle 100 between the “normal mode” and the “remote operation mode”.

The control device 180 is a computer that controls the vehicle 100. The control device 180 includes one or more processors 181 (hereinafter simply referred to as processors 181) and one or more storage devices 182 (hereinafter simply referred to as storage devices 182). The processor 181 executes various processes. For example, the processor 181 includes a Central Processing Unit (CPU). The storage device 182 stores various kinds of information necessary for processing by the processor 181. Examples of the storage device 182 include volatile memory, non-volatile memory, Hard Disk Drive (HDD), Solid State Drive (SSD), a storage medium, and the like. The control device 180 may include one or more Electronic Control Unit (ECU).

The vehicle control program PROG1 is a computer program executed by the processor 181. When the processor 181 executes the vehicle control program PROG1, the function of the control device 180 is realized. The vehicle control program PROG1 is stored in the storage device 182. Alternatively, the vehicle control program PROG1 may be recorded in a computer-readable recording medium.

The operation information OPE is information reflecting the operation amount and the operation status of the driving operation member 150 by the operator O. The operation amount and the operation state of the driving operation member 150 are detected by the sensor group 160. The control device 180 generates an operation information OPE based on the sensor group 160. For example, the operation data OPE includes an operation amount and an operation status of the driving operation member 150. As another example, the operation information OPE may include an actuator control amount calculated based on an operation amount of the driving operation member 150. The operation information OPE is stored in the storage device 182.

### 2-2. Normal Mode

In the normal mode, the control device 180 controls the actuators of the traveling device 120 based on the operation information OPE. Thus, the traveling (steering, acceleration, deceleration) of the vehicle 100 is controlled.

In the normal mode, the control device 180 controls the traveling assistance device 130 based on the operation information OPE. That is, in the normal mode, the control device 180 controls the traveling assistance device 130 in accordance with the operation of the switch group 155 by the operator O.

### 2-3. Remote Control Mode

In the remote control mode, the control device 180 prohibits the respective actuators of the traveling device 120 from being controlled based on the operation information OPE. This makes it possible to suppress unnecessary operation of the traveling device 120 during the remote control mode. This is preferable from the viewpoint of energy saving. In addition, unnecessary operation of the traveling device 120 is suppressed, and therefore, a surrounding pedestrian is suppressed from feeling uncomfortable with respect to the vehicle 100 at a stop.

Further, in the remote control mode, the control device 180 prohibits the traveling assistance device 130 from being controlled based on the operation information OPE. That is, in the remote control mode, the control of the traveling assistance device 130 in accordance with the operation of the switch group 155 by the operator O is prohibited. This makes it possible to suppress unnecessary operation of the traveling assistance device 130 during the remote control mode. This is preferable from the viewpoint of energy saving. In addition, unnecessary operation of the traveling assistance device 130 (light, winker, and wiper) is suppressed, so that the surrounding pedestrian is suppressed from feeling uncomfortable with respect to the vehicle 100 at a stop.

In the remote control mode, the control device 180 communicates with the remote operation target vehicle 200 via the communication device 110. The control device 180 transmits the operation information OPE to the remote operation target vehicles 200. Further, the control device 180 receives the vehicle information VCL from the remote operation target vehicle 200.

The vehicle information VCL includes information obtained by various sensors mounted on the remote operation target vehicle 200. For example, the vehicle information VCL includes image IMG obtained by the camera C mounted on the remote operation target vehicle 200. The vehicle information VCL may include audio information obtained by a microphone mounted on the remote operation target vehicle 200.

The control device 180 presents the vehicle information VCL to the operator O through the user interface 170. For example, the control device 180 displays IMG of images on the display device 171. As another example, the control device 180 may output audio information from the speaker 172. The operator O refers to the presented vehicle information VCL and recognizes a situation around the remote operation target vehicle 200. Then, the operator O remotely controls the remote operation target vehicle 200 by operating the driving operation member 150.

The vehicle information VCL may include information on a steering angle and a vehicle speed of the remote operation target vehicle 200. The control device 180 may apply a steering reaction force to the steering wheel 151 based on the steering angle and the vehicle speed of the remote operation target vehicle 200. More specifically, the vehicle 100 includes a reaction force actuator (not shown) that applies a steering reaction force to the steering wheel 151. The control device 180 calculates the reaction force control amount based on the steering angle and the vehicle speed of the remote operation target vehicle 200, and controls the reaction force actuator according to the reaction force control amount.

### 3. Specific Example of the Vehicle to be Remotely Controlled

### 3-1. Configuration Example

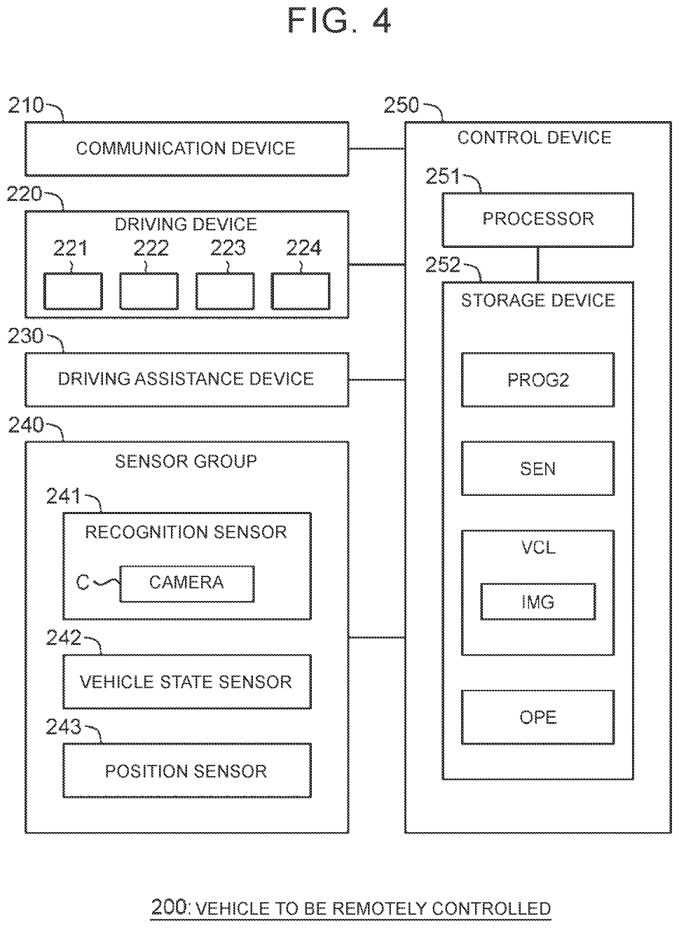

FIG. 4 is a block diagram illustrating a configuration example of the remote operation target vehicle 200 according to the present embodiment. The remote operation target vehicle 200 includes a communication device 210, a traveling device 220, a traveling assistance device 230, a sensor group 240, and a control device 250.

The communication device 210 communicates with the outside of the remote operation target vehicle 200. For example, the communication device 210 communicates with the vehicle 100 and the management device 300.

The traveling device 220 includes an actuator for realizing traveling (steering, acceleration, and deceleration) of the remote operation target vehicle 200. In particular, in the present embodiment, the remote operation target vehicle 200 is an XbyWire vehicle, and the traveling device 220 includes an actuator for XbyWire. More specifically, the traveling device 220 includes a steering actuator 221 for a steer-by-wire, a drive actuator 222 for a drive-by-wire, a brake actuator 223 for a brake-by-wire, and a shift actuator 224 for a shift-by-wire.

The traveling assistance device 230 assists the travel of the remote operation target vehicle 200. The traveling assistance device 230 includes at least one of a light, a winker, and a wiper.

The sensor group 240 includes a recognition sensor 241 that recognizes (detects) a situation around the remote operation target vehicle 200. For example, the recognition sensor 241 includes a camera C that captures a situation around the remote operation target vehicle 200. The recognition sensor 241 may further include a Laser Imaging Detection and Ranging (LIDAR), a radar, a sonar, and the like. The recognition sensor 241 may further include a microphone that detects sound around the remote operation target vehicle 200.

The sensor group 240 includes a vehicle state sensor 242 that detects a state of the remote operation target vehicle 200. The vehicle state sensor 242 includes a speed sensor, an acceleration sensor, a yaw rate sensor, a steering angle sensor, and the like.

Further, the sensor group 240 includes a position sensor 243 that detects the position and the azimuth of the remote operation target vehicle 200. For example, the position sensor 243 includes a Global Navigation Satellite System (GNSS).

The control device 250 is a computer that controls the remote operation target vehicle 200. The control device 250 includes one or more processors 251 (hereinafter simply referred to as processors 251) and one or more storage devices 252 (hereinafter simply referred to as storage devices 252). The processor 251 executes various processes. For example, the processor 251 includes a CPU. The storage device 252 stores various kinds of information necessary for processing by the processor 251. Examples of the storage device 252 include a volatile memory, a nonvolatile memory, and a HDD, SSD. The control device 250 may include one or more ECU.

The vehicle control program PROG2 is a computer program executed by the processor 251. When the processor 251 executes the vehicle control program PROG2, the function of the control device 250 is realized. The vehicle control program PROG2 is stored in the storage device 252. Alternatively, the vehicle control program PROG2 may be recorded in a computer-readable recording medium.

### 3-2. Sensor Detection Information

The control device 250 acquires the sensor detection information SEN using the sensor group 240. The sensor detection information SEN is stored in the storage device 252.

The sensor detection information SEN includes peripheral status information indicating a result of recognition by the recognition sensor 241. For example, the surroundings information includes image IMG captured by the camera C. The surrounding condition information may include point group information obtained by LIDAR. The surrounding situation information may include voice information detected by the microphone. The surrounding situation information may include object information about an object around the remote operation target vehicle 200. Examples of objects around the remote operation target vehicle 200 include pedestrians, other vehicles, white lines, signals, signs, and the like. The object information indicates a relative position and a relative speed of the object with respect to the remote operation target vehicle 200. For example, by analyzing IMG of images obtained by camera-C, an object can be identified and the relative position of the object can be calculated. It is also possible to identify an object based on the point cloud data obtained by LIDAR, and to acquire the relative position and the relative velocity of the object.

The sensor detection information SEN includes vehicle state information indicating a vehicle state detected by the vehicle state sensor 242.

Further, the sensor detection information SEN includes position information. The position information indicates a position and an azimuth of the remote operation target vehicle 200 obtained by the position sensor 243. Highly accurate position information may be acquired by Localization using map information and object information.

### 3-3. Vehicle Travel Control

The control device 250 executes vehicle travel control for controlling travel of the remote operation target vehicle 200. The vehicle travel control includes steering control, drive control, and braking control. The control device 250 executes vehicle travel control by controlling the traveling device 220.

The control device 250 may perform autonomous driving control based on the sensor detection information SEN. More specifically, the control device 250 generates a travel plan of the remote operation target vehicle 200 based on the sensor detection information SEN. Examples of the traveling plan include maintaining the current traveling lane, changing lanes, turning right and left, avoiding obstacles, and the like. Furthermore, the control device 250 generates a target trajectory required for the remote operation target vehicles 200 to travel in accordance with the travel plan based on the sensor detection information SEN. The target trajectory includes a target position and a target speed. Then, the control device 250 performs vehicle travel control so that the remote operation target vehicle 200 follows the target trajectory.

### 3-4. Processing Associated with Remote Control

When remote control of the remote operation target vehicle 200 is performed, the control device 250 communicates with the vehicle 100 via the communication device 210.

The control device 250 transmits the vehicle information VCL to the vehicle 100. The vehicle information VCL is information required for remote control and includes at least a part of the sensor detection information SEN. For example, the vehicle information VCL includes image IMG obtained by the camera C. The vehicle information VCL may include audio information obtained by a microphone. The vehicle information VCL may include vehicle status information (e.g., vehicle speed, steering angle). The vehicle information VCL may include location information.

In addition, the control device 250 receives the operation information OPE from the vehicles 100. The operation information OPE is information reflecting an operation amount and an operation state of the driving operation member 150 of the vehicle 100. The control device 250 performs the above-described vehicle travel control in accordance with the received operation information OPE. In addition, the control device 250 controls the traveling assistance device 230 in accordance with the received operation information OPE.

### 4. Processing Related to the Start of the Remote Control Mode

The operator O requests the start of the remote control mode by using the input device 173. For example, the input device 173 includes a switch for mode switching. The operator O operates the switch to request the start of the remote control mode.

Note that remote control may be requested from the remote operation target vehicle 200 side. For example, the remote operation target vehicle 200 during autonomous driving may face scenes in which autonomous driving is difficult. In this case, the remote operation target vehicle 200 stops and transmits a remote control request requesting remote control to the management device 300. The management device 300 assigns any vehicle 100 (operator O) to the remote operation target vehicle 200, and transmits a remote control request to the assigned vehicle 100. The control device 180 of the vehicle 100 presents the remote operation request to the operator O via the user interface 170. When the operator O accepts the remote operation request, the operator O requests the start of the remote operation mode using the input device 173.

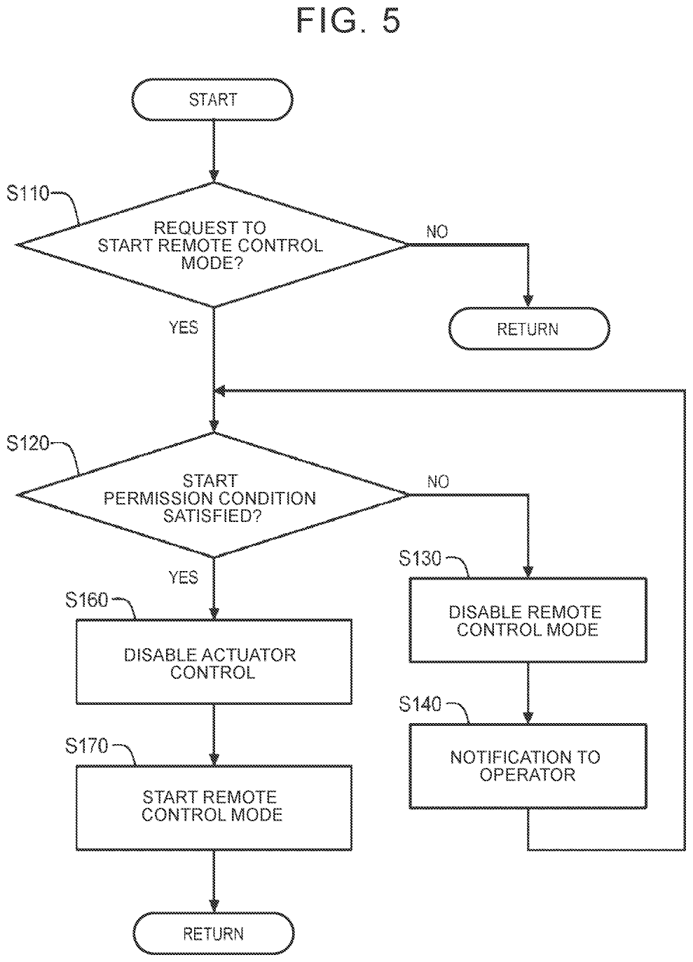

FIG. 5 is a flowchart illustrating an example of a process related to the start of the remote control mode.

In S110, the control device 180 determines whether or not the operator O has requested to initiate the remote control mode. When the remote control mode is requested to be started (S110; Yes), the process proceeds to S120.

In S120, the control device 180 determines whether or not the “start permission condition” for permitting the start of the remote control mode is satisfied. The start permission condition includes at least “the stop state of the vehicle 100 is maintained by the stop maintaining device 140”. The control device 180 determines whether or not the stop state of the vehicle 100 is maintained by checking the operation state of the stop maintaining device 140. The operation state of the stop maintaining device 140 is detected by the sensor group 160.

The start permission condition may further include “the communication quality of the communication between the vehicle 100 and the remote operation target vehicle 200 is equal to or higher than the threshold value”. Examples of the communication quality include communication speed, communication delay, Round Trip Time (RTT), Received Signal Strength Indicator (RSSI), and the like. The communication speed may be throughput. Communication quality varies depending on factors such as location, time, environment, etc. For example, the control device 180 can measure the communication quality based on the reception state of the data received from the remote operation target vehicle 200. As another example, the control device 180 may measure the communication quality based on the data transmitted to the remote operation target vehicle 200 and the feedback from the remote operation target vehicle 200. Various methods of measuring communication quality have been proposed, and the estimation method is not particularly limited in the present embodiment.

When the starting permission condition is not satisfied (S120; No), the process proceeds to S130. In S130, the control device 180 prohibits the remote control mode from being started.

In S140, the control device 180 sends a rejection notification to the operator O via the user interface 170 (the display device 171 and the speaker 172). For example, the dismissal notification includes at least one of: (A) a notification indicating that the start permission condition is not satisfied; (B) a notification indicating a cause that the start permission condition is not satisfied; and (C) a notification prompting the operator O to operate the stop maintaining device 140. The reason why the start permission condition is not satisfied is at least one of that the stop maintaining device 140 is not operating and that the communication quality is insufficient.

After S130, S140, the process returns to S120.

On the other hand, when the starting permission condition is satisfied (S120; Yes), the process proceeds to S160. In S160, the control device 180 disables the control of the respective actuators of the traveling device 120. In other words, the control device 180 prohibits the respective actuators of the traveling device 120 from being controlled based on the operation information OPE. In addition, the control device 180 may prohibit the traveling assistance device 130 from being controlled based on the operation information OPE.

In S170, the control device 180 initiates a remote control mode.

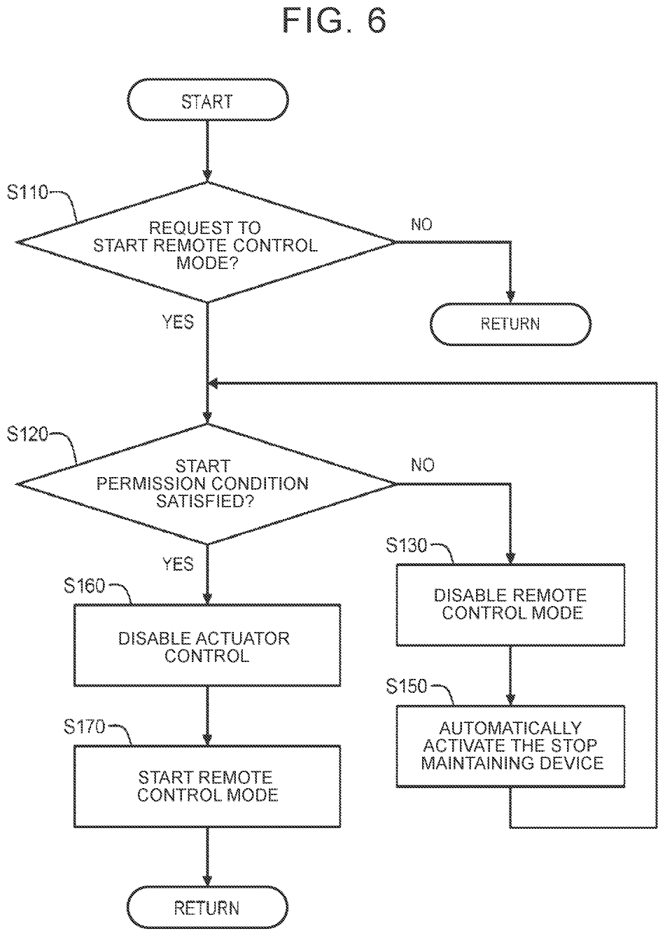

FIG. 6 is a flowchart illustrating another example of a process related to the start of the remote operation mode. Compared to the embodiment shown in FIG. 5, S140 is replaced by S150. A description that overlaps with the example illustrated in FIG. 5 will be omitted as appropriate.

In S150, the control device 180 automatically activates the stop maintaining device 140. For example, the stop maintaining device 140 is an electric parking brake. As another example, the stop maintaining device 140 may be a brake actuator 123 that generates a braking force sufficient to maintain the stop state of the vehicle 100.

After S130, S150, the process returns to S120.

### 5. Modified Example

The vehicle 100 need not necessarily include all functions of a steer-by-wire, a drive-by-wire, a brake-by-wire, and a shift-by-wire. Vehicle 100 may include only some of the functions of steer-by-wire, drive-by-wire, brake-by-wire, and shift-by-wire. Alternatively, the vehicle 100 may not be an XbyWire vehicle. In either case, in the remote control mode, the stop state of the vehicle 100 is maintained by the stop maintaining device 140.

What is claimed is:

1. A vehicle comprising:
a driving operation member operated by an operator to perform steering, acceleration, and deceleration;
a stop maintaining device that maintains a stop state; and
a control device,
wherein in a remote operation mode, the control device communicates with a remote operation target vehicle,
wherein in the remote operation mode, the control device transmits information reflecting an operation amount of the driving operation member to the remote operation target vehicle,
wherein in the remote operation mode, the control device shows information received from the remote operation target vehicle to the operator, and
wherein when the stop state of the vehicle is not maintained by the stop maintaining device, the control device prohibits the remote operation mode.

2. The vehicle according to claim 1,
wherein when starting the remote operation mode is requested by the operator, the control device determines whether a start permission condition is satisfied,
wherein the start permission condition includes at least that the stop state of the vehicle is maintained by the stop maintaining device,
wherein when the start permission condition is satisfied, the control device starts the remote operation mode, and
wherein when the start permission condition is not satisfied, the control device prohibits starting the remote operation mode.

3. The vehicle according to claim 2, wherein when the start permission condition is not satisfied, the control device sends a rejection notification to the operator.

4. The vehicle according to claim 3, wherein the rejection notification includes at least one of the following:
a notification indicating that the start permission condition is not satisfied;
a notification indicating why the start permission condition was not satisfied; and
a notification prompting the stop maintaining device to be activated.

5. The vehicle according to claim 2, wherein when the start permission condition is not satisfied, the control device automatically activates the stop maintaining device.

6. The vehicle according to claim 2, wherein the start permission condition further includes that a communication quality of communication between the vehicle and the remote operation target vehicle is equal to or higher than a threshold.

7. The vehicle according to claim 1, wherein the stop maintaining device includes a parking brake or an electric parking brake.

8. The vehicle according to claim 1,
further comprising at least one actuator for a function of at least one of a steer-by-wire and a drive-by-wire,
wherein in a normal mode, the control device controls the at least one actuator based on the operation amount of the driving operation member, and
wherein in the remote operation mode, the control device prohibits control of the at least one actuator based on the operation amount of the driving operation member.

9. The vehicle according to claim 1,
further comprising a traveling assistance device including at least one of a light, a turn signal, and a wiper,
wherein the driving operation member includes a switch for operating the traveling assistance device,
wherein in a normal mode, the control device controls the traveling assistance device in accordance with an operation of the switch by the operator, and
wherein in the remote operation mode, the control device prohibits controlling the traveling assistance device, based on the operation of the switch by the operator.

10. A vehicle control method of controlling a vehicle including a driving operation member operated by an operator to perform steering, acceleration, and deceleration, and a stop maintaining device that maintains a stop state, the vehicle control method comprising:
communicating with a remote operation target vehicle in a remote operation mode;
transmitting information reflecting an operation amount of the driving operation member to the remote operation target vehicle, in the remote operation mode;
showing information received from the remote operation target vehicle to the operator, in the remote operation mode; and
prohibiting the remote operation mode when the stop state of the vehicle is not maintained by the stop maintaining device.

11. A non-transitory storage medium that stores a vehicle control program that is executed by a computer, that controls a vehicle including a driving operation member that an operator operates to perform steering, acceleration, and deceleration, and a stop maintaining device that maintains a stop state, and that is configured to cause the computer to perform a process comprising:
communicating with a remote operation target vehicle in a remote operation mode;
transmitting information reflecting an operation amount of the driving operation member to the remote operation target vehicle, in the remote operation mode;
showing information received from the remote operation target vehicle to the operator, in the remote operation mode; and
prohibiting the remote operation mode when the stop state of the vehicle is not maintained by the stop maintaining device.
